(19) United States
(12) Patent Application Publication
(10) Pub. No.: US 2023/0045920 A1
(43) Pub. Date: Feb. 16, 2023

(54) POSITIVE ELECTRODE ACTIVE MATERIAL, SECONDARY BATTERY, ELECTRONIC DEVICE, AND VEHICLE

(71) Applicant: SEMICONDUCTOR ENERGY LABORATORY CO., LTD., Atsugi-shi, Kanagawa-ken (JP)

(72) Inventors: Jo SAITO, Atsugi, Kanagawa (JP); Yohei MOMMA, Isehara, Kanagawa (JP); Mayumi MIKAMI, Atsugi, Kanagawa (JP); Teruaki OCHIAI, Atsugi, Kanagawa (JP); Shunpei YAMAZAKI, Setagaya, Tokyo (JP)

(21) Appl. No.: 17/792,095

(22) PCT Filed: Jan. 6, 2021
(86) PCT No.: PCT/IB2021/050051

§ 371 Date: Jul. 11, 2022

(30) Foreign Application Priority Data
Jan. 17, 2020 (JP) 2020-005862

(51) Int. Cl. C01G 53/00; C01G 51/00; H01M 4/525

(52) U.S. Cl. CPC C01G 53/42; C01G 51/42; C01G 53/66; H01M 4/525; C01P 2006/40; C01P 2002/50; C01P 2002/77; H01M 2004/028

(57) ABSTRACT

A positive electrode active material having a crystal structure that is unlikely to be broken by repeated charging and discharging is provided. A positive electrode active material with high charge and discharge capacity is provided. One embodiment of the present invention is a positive electrode active material containing lithium, cobalt, nickel, and oxygen; in which a molar ratio of lithium, cobalt, and nickel is lithium: cobalt: nickel=1:1−x: x (0.3<x<0.75); in which the average of a bond distance between cobalt and oxygen and a bond distance between nickel and oxygen is longer than or equal to 1.94×10⁻¹⁰ m and shorter than or equal to 2.1×10⁻¹⁰ m in a crystal structure of the positive electrode active material; and in which the average of an angle formed between a line connecting cobalt to an adjacent oxygen and a line connecting cobalt to another adjacent oxygen and an angle formed between a line connecting nickel to an adjacent oxygen and a line connecting nickel to another adjacent oxygen is greater than or equal to 86.5° and less than 90°.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a semiconductor device, a display device, a light-emitting device, a power storage device, a lighting device, an electronic device, or a manufacturing method thereof.

One embodiment of the present invention relates to a vehicle using a semiconductor device, a display device, a light-emitting device, a secondary battery, a power storage device, or a memory device, or an electronic device for a vehicle provided in a vehicle.

Note that electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry, and the lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Document 1 to Patent Document 3). In addition, crystal structures of positive electrode active materials have been studied (Non-Patent Document 1 to Non-Patent Document 3).

X-ray diffraction (XRD) is one of methods used for analysis of a crystal structure of a positive electrode active material. With the use of the ICSD (Inorganic Crystal Structure Database) described in Non-Patent Document 4, XRD data can be analyzed.

### REFERENCE

### Patent Document

[Patent Document 1] Japanese Published Patent Application No. H8-236114
[Patent Document 2] Japanese Published Patent Application No. 2002-124262
[Patent Document 3] Japanese Published Patent Application No. 2002-358953

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LixCoO₂ (0.0≤x≤1.0)”, Physical Review B, 80 (16); 165114.
[Non-Patent Document 3] Zhaohui Chen et al., “Staging Phase Transitions in LixCoO₂”, Journal of The Electrochemical Society, 2002, 149 (12), A1604-A1609.
[Non-Patent Document 4] Belsky, A. et al., “New developments in the Inorganic Crystal Structure Database (ICSD): accessibility in support of materials research and design”, Acta Cryst., (2002) B58, 364-369.

### SUMMARY OF THE INVENTION

### Problems to be Solved by the Invention

However, development of lithium-ion secondary batteries and positive electrode active materials used therein has room for improvement in terms of charge and discharge capacity, cycle performance, reliability, safety, cost, and the like.

An object of one embodiment of the present invention is to provide a positive electrode active material which suppresses a decrease in charge and discharge capacity due to charge and discharge cycles when used in a lithium-ion secondary battery. Another object is to provide a positive electrode active material having a crystal structure that is unlikely to be broken by repeated charging and discharging. Another object is to provide a positive electrode active material with high charge and discharge capacity. Another object is to provide a highly safe or highly reliable secondary battery.

Another object of one embodiment of the present invention is to provide a novel material, a novel active material particle, a novel power storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

### Means for Solving the Problems

Another embodiment of the present invention is a positive electrode active material containing lithium, cobalt, a transition metal M, and oxygen, in which a molar ratio of the lithium, the cobalt, and the transition metal M is the lithium: the cobalt: the transition metal M=1.03: 1−x: x (0.3<x<0.75).

Another embodiment of the present invention is a positive electrode active material containing lithium, cobalt, a transition metal M, and oxygen, in which a molar ratio of the lithium, the cobalt, and the transition metal M is the lithium: the cobalt: the transition metal M =1.03: 1−x: x (0.4≤x≤0.6).

In the above positive electrode active material, the transition metal M is nickel.

Another embodiment of the present invention is a positive electrode active material containing lithium, a transition metal M, and oxygen, in which an average of a bond distance d between the transition metal M and the oxygen is longer than or equal to 1.94×10⁻¹⁰ m and shorter than or equal to 2.1×10⁻¹⁰ m in a crystal structure of the positive electrode active material.

Another embodiment of the present invention is a positive electrode active material containing lithium, a transition metal M, and oxygen, in which an average of an angle θ formed between a line connecting the transition metal M to an adjacent oxygen and a line connecting the transition metal M to another adjacent oxygen is greater than or equal to 86.5° and less than 90° in a crystal structure of the positive electrode active material.

In the above positive electrode active material, the transition metal M is cobalt and nickel.

Another embodiment of the present invention is a positive electrode active material containing lithium, cobalt, nickel, and oxygen; in which a molar ratio of the lithium, the cobalt, and the nickel is the lithium: the cobalt: the nickel=1: 1−x: x (0.3<x<0.75); in which a bond distance d that is an average of a bond distance d_{Co} between the cobalt and the oxygen and a bond distance d_{Ni} between the nickel and the oxygen is longer than or equal to 1.94×10⁻¹⁰ m and shorter than or equal to 2.1×10⁻¹⁰ m in a crystal structure of the positive electrode active material; and in which an angle θ that is an average of an angle θ_{Co} formed between a line connecting the cobalt to an adjacent oxygen and a line connecting the cobalt to another adjacent oxygen and an angle θ_{Ni} formed between a line connecting the nickel to an adjacent oxygen and a line connecting the nickel to another adjacent oxygen is greater than or equal to 86.5° and less than 90° in a crystal structure of the positive electrode active material.

Another embodiment of the present invention is a secondary battery containing the positive electrode active material described above.

Another embodiment of the present invention is an electronic device including the secondary battery described above.

Another embodiment of the present invention is a vehicle including the secondary battery described above.

### Effect of the Invention

When a positive electrode active material of one embodiment of the present invention is used in a lithium-ion secondary battery, a positive electrode active material which suppresses a decrease in charge and discharge capacity due to charge and discharge cycles can be provided. A positive electrode active material having a crystal structure that is unlikely to be broken by repeated charging and discharging can be provided. In particular, one embodiment of the present invention can provide a positive electrode active material which suppresses a decrease in charge and discharge capacity due to charge and discharge cycles at high voltage even in a high-temperature environment and has a crystal structure that is unlikely to be broken by repeated charging and discharging.

A positive electrode active material with high charge and discharge capacity can be provided. A highly safe or highly reliable secondary battery can be provided. One embodiment of the present invention can provide a novel material, a novel active material particle, a novel power storage device, or a manufacturing method thereof.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1 is a diagram showing a crystal structure of a positive electrode active material.

FIG. 2 is a diagram showing a crystal structure of a positive electrode active material.

FIG. 3A is a perspective view of a secondary battery, FIG. 3B is a cross-sectional perspective view thereof, and FIG. 3C is a schematic cross-sectional view in charging.

FIG. 4A is a perspective view of a secondary battery, FIG. 4B is a cross-sectional perspective view thereof, FIG. 4C is a perspective view of a battery pack including a plurality of secondary batteries, and FIG. 4D is a top view thereof.

FIG. 5A and FIG. 5B are diagrams illustrating an example of a secondary battery.

FIG. 6A and FIG. 6B are diagrams illustrating a laminated secondary battery.

FIG. 7A and FIG. 7B are diagrams illustrating examples of a secondary battery.

FIG. 8A, FIG. 8B, FIG. 8C, FIG. 8D, and FIG. 8E are perspective views illustrating electronic devices.

FIG. 9A and FIG. 9B are diagrams showing lattice constants of samples fabricated in Examples.

FIG. 10A is a diagram showing lattice distances of the samples fabricated in Examples, and FIG. 10B is a diagram showing bond angles.

FIG. 11 is a diagram showing charge and discharge curves of the samples fabricated in Examples.

FIG. 12 is a diagram showing charge and discharge curves of the samples fabricated in Examples.

FIG. 13 is a diagram showing charge and discharge curves of the sample fabricated in Examples.

### MODE FOR CARRYING OUT THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

In this specification and the like, the Miller index is used for the expression of crystal planes and orientations. An individual plane that shows a crystal plane is denoted by “( )”. In the crystallography, a bar is placed over a number in the expression of crystal planes, orientations, and space groups; in this specification and the like, because of application format limitations, crystal planes, orientations, and space groups are sometimes expressed by placing a minus sign (−) in front of the number instead of placing a bar over the number.

In this specification and the like, segregation refers to a phenomenon in which, in a solid made of a plurality of elements (e.g., A, B, and C), a certain element (e.g., B) is spatially non-uniformly distributed.

In this specification and the like, uniformity refers to a phenomenon in which, in a solid made of a plurality of elements (e.g., A, B, and C), a certain element (e.g., A) is distributed with similar features in specific regions. Note that it is acceptable for the specific regions to have substantially the same concentration of the element. For example, a difference in the concentration of the element between the specific regions can be 10% or less. Examples of the specific regions include a surface, a projection, a depression, and an inner region.

In this specification and the like, a region that is approximately 10 nm or less in depth from a surface toward an inner portion of a positive electrode active material is referred to as a surface portion. A plane generated by a split or a crack may also be referred to as a surface. A region in a deeper position than the surface portion of the positive electrode active material is referred to as an inner region. Furthermore, a region that is 3 nm or less in depth from the surface toward the inner portion in the surface portion of the positive electrode active material is referred to as an outermost surface layer. The surface of the positive electrode active material refers to a surface of a composite oxide including the surface portion including the outermost surface layer, the inner region, and the like. Thus, the positive electrode active material does not have carbonic acid, a hydroxy group, or the like chemically adsorbed after the fabrication. Furthermore, an electrolyte solution, a binder, a conductive material, and a compound originating from any of these that are attached to the positive electrode active material are not contained either. Not all of the regions of the positive electrode active material need to be a region including a lithium site that contributes to charging and discharging.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may partly exist as long as two-dimensional diffusion of lithium ions is possible. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may partly exist.

In this specification and the like, a mixture refers to a plurality of materials mixed. Among mixtures, a mixture in which mutual diffusion of elements has occurred may be referred to as a composite. The composite may partly contain an unreacted material.

In this specification and the like, a theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the charge depth obtained when all lithium that can be inserted and extracted is inserted is 0, and the charge depth obtained when all lithium that can be inserted and extracted and is contained in a positive electrode active material is extracted is 1.

In this specification and the like, charging refers to transfer of lithium ions from a positive electrode to a negative electrode in a battery and transfer of electrons from a positive electrode to a negative electrode in an external circuit. For a positive electrode active material, extraction of lithium ions is called charging.

In general, a positive electrode active material having the layered rock-salt crystal structure has an unstable crystal structure when lithium between layers consisting of a transition metal and oxygen decreases. For this reason, in a general secondary battery using lithium cobalt oxide, the charge depth, the charge voltage (in the case of a lithium counter electrode), and the charge capacity are limited to about 0.4, 4.3 V, and 160 mAh/g, respectively, in charging.

In contrast, a positive electrode active material with a charge depth of greater than or equal to 0.74 and less than or equal to 0.9, more specifically, a charge depth of greater than or equal to 0.8 and less than or equal to 0.83 is referred to as a high-voltage charged positive electrode active material. Thus, for example, LiCoO₂ charged to a charge capacity of 219.2 mAh/g is a high-voltage charged positive electrode active material. In addition, LiCoO₂ that is subjected to constant current charging in an environment at 25° C. and charge voltage of higher than or equal to 4.525 V and lower than or equal to 4.65 V (in the case of a lithium counter electrode), and then subjected to constant voltage charging until the current value becomes 0.01 C or approximately 1/5 to 1/100 of the current value at the time of the constant current charging is also referred to as a high-voltage charged positive electrode active material. Note that C is an abbreviation for Capacity rate, and 1C refers to the current amount with which the charge and discharge capacity of a secondary battery is fully charged or fully discharged in one hour.

Similarly, discharging refers to transfer of lithium ions from a negative electrode to a positive electrode in a battery and transfer of electrons from a negative electrode to a positive electrode in an external circuit. For a positive electrode active material, insertion of lithium ions is called discharging. A positive electrode active material with a charge depth of less than or equal to 0.06 or a positive electrode active material from which more than or equal to 90% of the charge capacity is discharged from a high-voltage charged state is referred to as a sufficiently discharged positive electrode active material. For example, LiCoO₂ with a charge capacity of 219.2 mAh/g is in a state of being charged with high voltage, and a positive electrode active material from which more than or equal to 197.3 mAh/g, which is 90% of the charge capacity, is discharged is a sufficiently discharged positive electrode active material. In addition, LiCoO₂ that is subjected to constant current discharging in an environment at 25° C. until the battery voltage becomes lower than or equal to 3 V (in the case of a lithium counter electrode) is also referred to as a sufficiently discharged positive electrode active material.

In this specification and the like, an example in which a lithium metal is used as a counter electrode in a secondary battery using a positive electrode and a positive electrode active material of one embodiment of the present invention is described in some cases; however, the secondary battery of one embodiment of the present invention is not limited to this example. Another material such as graphite or lithium titanate may be used as a negative electrode, for example. The properties of the positive electrode and the positive electrode active material of one embodiment of the present invention, such as a crystal structure unlikely to be broken by repeated charging and discharging and excellent cycle performance, are not affected by the material of the negative electrode. The secondary battery of one embodiment of the present invention using a lithium counter electrode is charged and discharged at a voltage higher than a general charge voltage of approximately 4.6 V in some cases; however, charging and discharging may be performed at a lower voltage. Charging and discharging at a lower voltage may lead to the cycle performance better than that described in this specification and the like.

### Embodiment 1

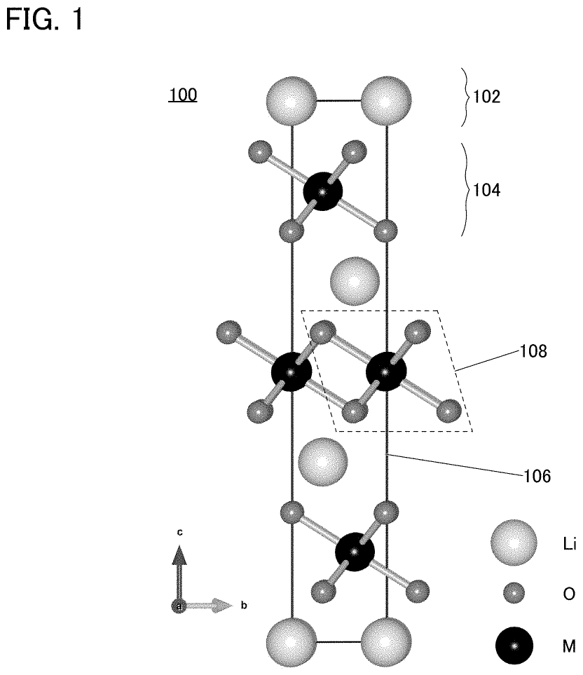

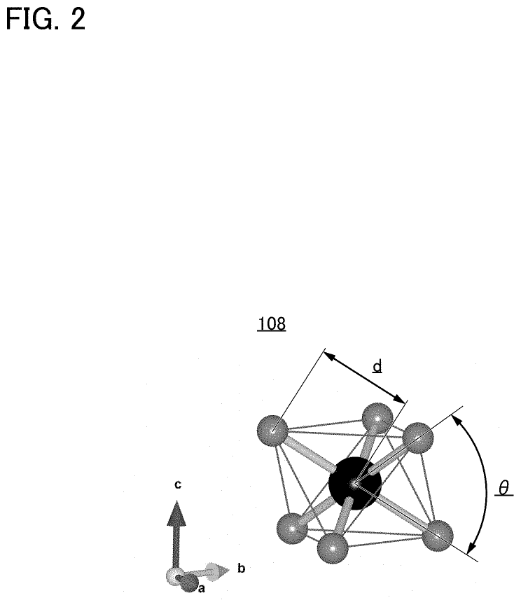

In this embodiment, a positive electrode active material of one embodiment of the present invention will be described with reference to FIG. 1 and FIG. 2.

The positive electrode active material of one embodiment of the present invention contains at least lithium, a transition metal M, and oxygen. FIG. 1 is a diagram showing a crystal structure of a positive electrode active material 100 of one embodiment of the present invention. FIG. 2 is a diagram showing an octahedral structure consisting of the transition metal M and oxygen shown in a region 108 in FIG. 1. The orientations (the arrows) shown in FIG. 2 are described on the basis of orientations of a space group R-3m.

In the crystal structure of the positive electrode active material 100 shown in FIG. 1, a bond with a certain atomic distance or shorter is shown by a line. A line 106 indicates a unit cell, and the positive electrode active material 100 has a crystal structure in which the structure in the frame is repeated as the minimum unit.

As the transition metal M contained in the positive electrode active material 100, a metal that can form, together with lithium, a composite oxide having the layered rock-salt structure belonging to the space group R-3m is preferably used. Specifically, at least one or more of cobalt, nickel, and manganese can be used.

Note that in the case where two or more kinds are used as the transition metal M, two kinds of metals of cobalt and manganese or two kinds of metals of cobalt and nickel may be used. Furthermore, three kinds of metals of cobalt, manganese, and nickel may be used as the transition metal M. In other words, the positive electrode active material 100 can contain a composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

In the case where two or more kinds of metals are used as the transition metal M, different transition metals are denoted by a transition metal M1 or a transition metal M2 in some cases.

When nickel is contained as the transition metal M in addition to cobalt, a shift in a layered structure formed of octahedrons of cobalt and oxygen is sometimes inhibited. This is preferable because the inhibition of the shift enables higher stability of the crystal structure particularly in a high-temperature charged state in some cases.

As shown in FIG. 1, the positive electrode active material 100 has a layered structure of a layer 102 containing lithium and a layer 104 containing the transition metal.

Here, charging refers to transfer of lithium ions from a positive electrode to a negative electrode in a battery and transfer of electrons from a positive electrode to a negative electrode in an external circuit. That is, in the case of charging, lithium ions are extracted from the positive electrode active material. In general, a positive electrode active material having the layered rock-salt crystal structure has an unstable crystal structure when lithium between layers consisting of the transition metal M and oxygen decreases.

In view of the above, as shown in FIG. 2, the average of a bond distance d (bond distance dₐᵥₑ) between the transition metal M and oxygen is longer than or equal to 1.94×10⁻¹⁰ m and shorter than or equal to 2.1×10⁻¹⁰ m, preferably longer than or equal to 1.95×10⁻¹⁰ m and shorter than or equal to 1.98×10⁻¹⁰ m in the positive electrode active material of one embodiment of the present invention. Note that as for the numerical ranges stepwisely described in this specification, the upper limit or the lower limit in a certain numerical range may be replaced with the upper limit or the lower limit in any of the other numerical ranges stepwisely described in this specification.

In the case where the bond distance dₐᵥₑ between the transition metal M and oxygen is within the above range in the positive electrode active material, distortion of the octahedral structure consisting of the transition metal M and oxygen is small. That is, even when lithium between layers consisting of the transition metal M and oxygen decreases, a stable crystal structure can be maintained. In particular, deterioration of the crystal structure due to heat is presumably inhibited, and the crystal structure can be stably maintained even in a high-temperature environment. Thus, with the positive electrode active material, high stability to heat and excellent cycle performance even in a high-temperature environment can be achieved.

On the other hand, when the bond distance dₐᵥₑ between the transition metal M and oxygen is longer than or equal to a certain distance, it is highly possible that the interatomic bond becomes weak and the crystal structure cannot be maintained. Accordingly, it can be presumed that the bond distance dₐᵥₑ between the transition metal M and oxygen has an appropriate range.

In the positive electrode active material of one embodiment of the present invention, the average of an angle θ (hereinafter, also referred to as a bond angle θ) (the average is referred to as a bond angle θₐᵥₑ) formed between a line connecting the transition metal M to an adjacent oxygen and a line connecting the transition metal M to another adjacent oxygen is greater than or equal to 86.5° and less than or equal to 90°. Note that the bond angle Bis preferably close to 90°, in which case distortion of the octahedral structure consisting of the transition metal M and oxygen is small.

In the case where the bond angle θₐᵥₑ between the transition metal M and oxygen is within the above range in the positive electrode active material, distortion of the octahedral structure consisting of the transition metal M and oxygen is small. That is, even when lithium between layers consisting of the transition metal M and oxygen decreases, a stable crystal structure can be maintained. In particular, deterioration of the crystal structure due to heat is presumably inhibited, and the crystal structure can be stably maintained even in a high-temperature environment. Thus, with the positive electrode active material, high stability to heat and excellent cycle performance even in a high-temperature environment can be achieved.

Note that even in the case where the bond distance dₐᵥₑ between the transition metal M and oxygen is longer than or equal to a certain distance, it is highly possible that the crystal structure is stable when the value of the bond angle θₐᵥₑ between the transition metal M and oxygen is appropriate. Therefore, when one or both of the bond distance dₐᵥₑ between the transition metal M and oxygen and the bond angle θₐᵥₑ between the transition metal M and oxygen is within the appropriate range, it can be presumed that the positive electrode active material has high stability to heat and can have excellent cycle performance even in a high-temperature environment.

The bond distance d or the bond angle θ between the transition metal M and oxygen can be controlled by the transition metal M contained in the positive electrode active material.

Specifically, a Li—Co—Ni oxide in which two kinds of the transition metals M, i.e., cobalt as the transition metal M1 and nickel as the transition metal M2, are used is described.

In the case where the molar ratio of the metal elements in the Li—Co—Ni oxide is Li:Co: Ni=1.03:1−x: x, a molar ratio x of nickel (N molar ratio x) is 0<x<1, preferably 0.3<x<0.75, further preferably 0.4≤x≤0.6. In particular, when the molar ratio x of nickel is 0.3<x≤0.6, the bond distance dₐᵥₑ can be longer than or equal to 1.94×10⁻¹⁰ m and less than or equal to 2.0×10⁻¹⁰ m.

Furthermore, when the molar ratio x of nickel (Ni molar ratio x) is 0<x<1, preferably 0.3<x<0.75, further preferably 0.4≤x≤0.6 in the Li—Co—Ni oxide, the bond angle θₐᵥₑ can be greater than or equal to 86.5° and less than 90°.

In the case where the bond distance dₐᵥₑ between cobalt (Co) and oxygen is approximately 1.91×10⁻¹⁰ m in the Li—Co—Ni oxide, the bond distance dₐᵥₑ between nickel (Ni) and oxygen is longer than the bond distance dₐᵥₑ between cobalt (Co) and oxygen. Thus, the bond distance dₐᵥₑ can be controlled by substituting nickel (Ni) for part of cobalt (Co).

Furthermore, the bond angle θₐᵥₑ between cobalt (Co) and oxygen in a Li—Co oxide can also be controlled by substituting nickel (Ni) for part of cobalt (Co).

The use of the above positive electrode active material can provide a lithium battery having high stability to heat and excellent cycle performance even in a high-temperature environment.

### <Contained Element>

The positive electrode active material 100 may contain an additive in addition to lithium, the transition metal M, and oxygen. The positive electrode active material 100 can be regarded as a composite oxide represented by LiMO₂ to which an additive is added. Note that the composition is not strictly limited to Li:M:O=1:1:2 as long as the positive electrode active material of one embodiment of the present invention has a crystal structure of a lithium composite oxide represented by LiMO₂.

As the additive contained in the positive electrode active material 100, at least one of magnesium, fluorine, aluminum, titanium, zirconium, vanadium, iron, chromium, niobium, cobalt, arsenic, zinc, silicon, sulfur, phosphorus, and boron is preferably used. Such elements further stabilize a crystal structure included in the positive electrode active material 100 in some cases, as described later.

The positive electrode active material 100 can contain lithium cobalt oxide to which magnesium and fluorine are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. Note that in this specification and the like, the additive may be rephrased as a mixture, a constituent of a material, an impurity, or the like.

Note that as the additive, fluorine, aluminum, titanium, zirconium, vanadium, iron, chromium, niobium, cobalt, arsenic, zinc, silicon, sulfur, phosphorus, or boron is not necessarily contained.

In order to prevent the breakage of a layered structure formed of octahedrons of cobalt and oxygen even when lithium is extracted from the positive electrode active material 100 of one embodiment of the present invention by charging, the surface portion having a high concentration of the additive, i.e., the outer portion of a particle, reinforces the positive electrode active material 100.

The gradient of the concentration of the additive is preferably uniform in the surface portion of the positive electrode active material 100. When the surface portion partly has reinforcement, stress might be concentrated on parts that do not have reinforcement. The concentration of stress on part of a particle might cause defects such as cracks from that part, leading to cracking of the positive electrode active material and a decrease in charge and discharge capacity.

Note that when an excess amount of material is added, it is highly possible that insertion and extraction of Li in the surface portion of the positive electrode active material 100 is disturbed, resulting in a decrease in charge and discharge capacity. When the additive material is deficient, the material cannot exist uniformly in the surface portion of the positive electrode active material 100. Therefore, the concentration of the additive material is, to the entire positive electrode active material, higher than or equal to 0.3 atomic % and lower than or equal to 3.0 atomic %, for example.

Magnesium, which is one of additive elements X, is divalent and is more stable in lithium sites than in transition metal sites in a layered rock-salt crystal structure; thus, magnesium is likely to enter the lithium sites. An appropriate concentration of magnesium in the lithium sites of the surface portion facilitates maintenance of the layered rock-salt crystal structure. An appropriate magnesium concentration is preferable because an adverse effect on insertion and extraction of lithium in charging and discharging can be prevented. However, excess magnesium might adversely affect insertion and extraction of lithium.

Aluminum, which is one of additive elements Y, is trivalent and has a high bonding strength with oxygen. Thus, when aluminum is contained as an additive and exists in the lithium sites, a change in the crystal structure can be inhibited. Hence, the positive electrode active material 100 can have the crystal structure that is unlikely to be broken by repeated charging and discharging.

An oxide of titanium is known to have superhydrophilicity. Accordingly, the positive electrode active material 100 including an oxide of titanium in the surface portion presumably has good wettability with respect to a high-polarity solvent. Such a positive electrode active material 100 and a high-polarity electrolyte solution can have favorable contact at the interface therebetween and presumably inhibit an internal resistance increase when a secondary battery is formed using such a positive electrode active material 100.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can suppress a charge and discharge capacity decrease due to repeated charging and discharging.

A short circuit of a secondary battery might cause not only malfunction in charging operation and/or discharging operation of the secondary battery but also heat generation and firing. In order to obtain a safe secondary battery, a short-circuit current is preferably inhibited even at a high charge voltage. In the positive electrode active material 100 of one embodiment of the present invention, a short-circuit current is inhibited even at a high charge voltage; thus, a secondary battery having high charge and discharge capacity and a high level of safety can be obtained.

It is preferable that a secondary battery using the positive electrode active material 100 of one embodiment of the present invention can have high charge and discharge capacity, excellent charge and discharge cycle performance, and safety simultaneously.

### «Grain Boundary»

A slight amount of magnesium or halogen contained in the positive electrode active material 100 of one embodiment of the present invention may randomly exist in the inner region, but part of the element is further preferably segregated at a grain boundary.

In other words, the magnesium concentration in the crystal grain boundary and its vicinity of the positive electrode active material 100 of one embodiment of the present invention is preferably higher than that in the other regions in the inner region. In addition, the halogen concentration in the crystal grain boundary and its vicinity is also preferably higher than that in the other regions in the inner region.

The crystal grain boundary is a plane defect. Thus, the crystal grain boundary tends to be unstable and its crystal structure easily starts to change like the surface of the particle. Therefore, the higher the magnesium concentration in the crystal grain boundary and its vicinity is, the more effectively the change in the crystal structure can be inhibited.

When the magnesium concentration and the halogen concentration are high at the crystal grain boundary and the vicinity thereof, the magnesium concentration and the halogen concentration in the vicinity of a surface generated by a crack are also high even when the crack is generated along the crystal grain boundary of the particle of the positive electrode active material 100 of one embodiment of the present invention. Thus, the positive electrode active material including a crack can also have an increased corrosion resistance to hydrofluoric acid.

Note that in this specification and the like, the vicinity of the crystal grain boundary refers to a region of approximately 10 nm from the grain boundary.

This embodiment can be implemented in combination with the other embodiments or the other examples.

### Embodiment 2

In this embodiment, examples of the shape of a secondary battery including the positive electrode active material manufactured by the manufacturing method described in the above embodiment are described. For the materials used for the secondary battery described in this embodiment, the description of the above embodiment can be referred to.

### [Coin-Type Secondary Battery]

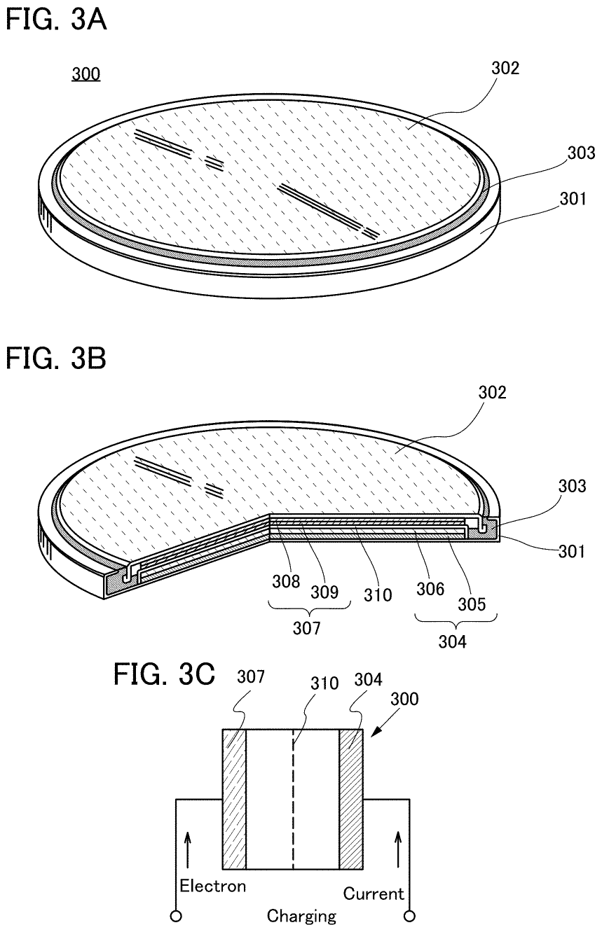

An example of a coin-type secondary battery is described. FIG. 3A is an external view of a coin-type (single-layer flat type) secondary battery, and FIG. 3B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and a separator 310 are immersed in the electrolyte solution; as illustrated in FIG. 3(B), the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

When the positive electrode active material described in the above embodiment is used in the positive electrode 304, the coin-type secondary battery 300 with little deterioration and high safety can be obtained.

### [Separator]

The secondary battery preferably includes a separator. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

Deterioration of the separator in high-voltage charging and discharging can be inhibited and thus the reliability of the secondary battery can be improved because oxidation resistance is improved when the separator is coated with the ceramic-based material. In addition, when the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

Here, a current flow in charging a secondary battery is described with reference to FIG. 3C. When a secondary battery using lithium is regarded as a closed circuit, the direction of transfer of lithium ions is the same as the direction of current flow. Note that in a secondary battery using lithium, the anode and the cathode are interchanged in charging and discharging, and the oxidation reaction and the reduction reaction are interchanged; thus, an electrode with a high reaction potential is called the positive electrode and an electrode with a low reaction potential is called the negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of terms such as anode and cathode related to oxidation reaction and reduction reaction might cause confusion because the anode and the cathode are reversed in charging and in discharging. Thus, the terms such as anode and cathode are not used in this specification. If the term such as an anode or a cathode is used, whether it is at the time of charge or discharge is noted and whether it corresponds to a positive electrode or a negative electrode is also noted.

Two terminals illustrated in FIG. 3C are connected to a charger, and the secondary battery 300 is charged. As the charge of the secondary battery 300 proceeds, a potential difference between the electrodes increases.

### [Cylindrical Secondary Battery]

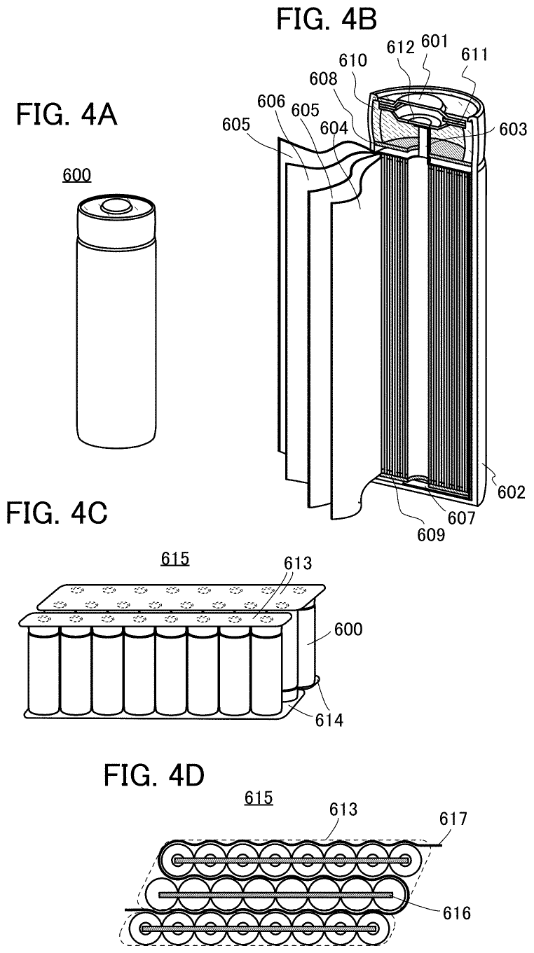

An example of a cylindrical secondary battery is described with reference to FIG. 4A to FIG. 4D. As illustrated in FIG. 4A and FIG. 4B, a cylindrical secondary battery 600 includes a positive electrode cap (battery lid) 601 on a top surface and a battery can (outer can) 602 on a side surface and a bottom surface. The positive electrode cap and the battery can (outer can) 602 are insulated from each other by a gasket (insulating gasket) 610.

FIG. 4B is a schematic cross-sectional view of a cylindrical secondary battery. Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel or aluminum, for example, in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical secondary battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. The positive electrode terminal 603 and the negative electrode terminal 607 can each be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery increases and exceeds a predetermined threshold value. In addition, the PTC element 611 is a thermally sensitive resistor whose resistance increases as temperature rises, and limits the amount of current by increasing the resistance to prevent abnormal heat generation. Barium titanate (BaTiO₃)-based semiconductor ceramics or the like can be used for the PTC element.

As illustrated in FIG. 4C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 4D is a top view of the module 615. The conductive plate 613 is shown by a dotted line for clarity of the drawing. As illustrated in FIG. 4D, the module 615 may include a conductive wire 616 electrically connecting the plurality of secondary batteries 600 with each other. The conductive plate 613 can be provided over and overlap the conductive wire 616. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature.

When the positive electrode active material manufactured by the manufacturing method described in the above embodiment is used in the positive electrode 604, the cylindrical secondary battery 600 with little deterioration and high safety can be obtained.

### [Structure Examples of Secondary Battery]

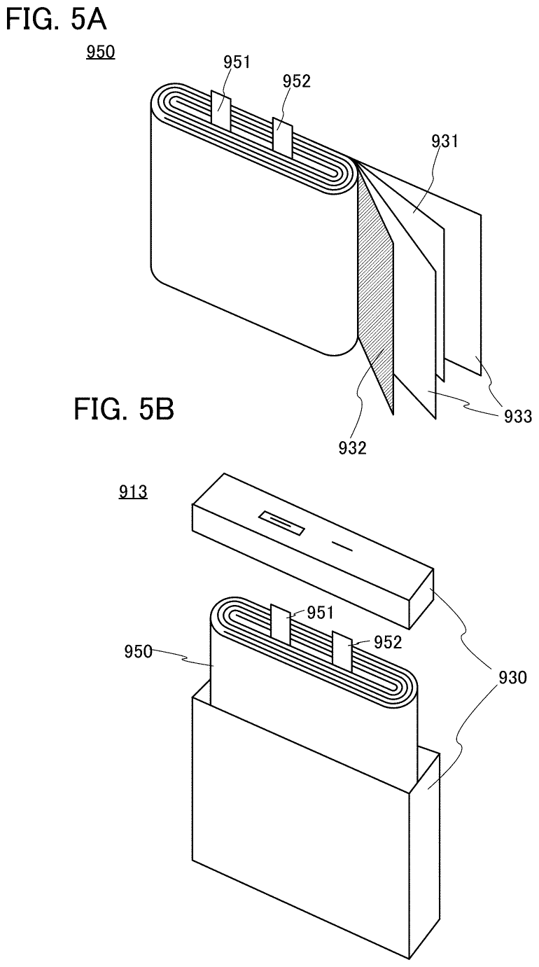

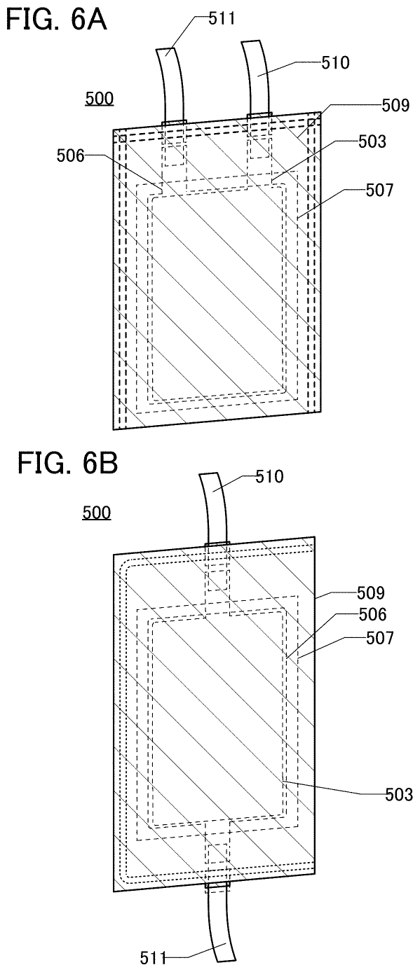

Other structural examples of power storage devices will be described with reference to FIG. 5 and FIG. 6.

FIG. 5A illustrates a structure of a wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks of the negative electrode 931, the positive electrode 932, and the separator 933 may be further overlaid.

A secondary battery 913 illustrated in FIG. 5B includes a wound body 950 provided with a terminal 951 and a terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 5B, the housing 930 that has been divided is illustrated for convenience; however, in reality, the wound body 950 is covered with the housing 930, and the terminal 951 and the terminal 952 extend to the outside of the housing 930. For the housing 930, a metal material (e.g., aluminum) or a resin material can be used.

### [Laminated Secondary Battery]

Next, an example of a laminated secondary battery is described with reference to FIG. 6A and FIG. 6B.

FIG. 6A illustrates an example of an external view of a laminated secondary battery 500. FIG. 6B illustrates another example of an external view of the laminated secondary battery 500.

In FIG. 6A and FIG. 6B, a positive electrode 503, a negative electrode 506, a separator 507, an exterior body 509, a positive electrode lead electrode 510, and a negative electrode lead electrode 511 are included.

The laminated secondary battery 500 includes a wound body or a plurality of positive electrodes 503, separators 507, and negative electrodes 506 that are each strip-shaped.

The wound body includes the negative electrode 506, the positive electrode 503, and the separator 507. The wound body is, like the wound body illustrated in FIG. 5A, obtained by winding a sheet of a stack in which the negative electrode 506 overlaps with the positive electrode 503 with the separator 507 provided therebetween.

The secondary battery may include the plurality of positive electrodes 503, separators 507, and negative electrodes 506 that are each strip-shaped in a space formed by a film serving as the exterior body 509.

A manufacturing method of the secondary battery including the plurality of positive electrodes 503, separators 507, and negative electrodes 506 that are each strip-shaped is described below.

First, the negative electrodes 506, the separators 507, and the positive electrodes 503 are stacked. This embodiment describes an example using five negative electrodes and four positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrodes 506, the separators 507, and the positive electrodes 503 are placed over the exterior body 509.

As the exterior body 509, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The exterior body 509 is folded to interpose the stack therebetween. Then, the outer edges of the exterior body 509 are bonded to each other. The bonding can be performed by thermocompression, for example. In this bonding, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert gas atmosphere. Lastly, the inlet is sealed by bonding. In the above manner, the laminated secondary battery 500 can be manufactured.

When the positive electrode active material described in the above embodiment is used in the positive electrode 503, the secondary battery 500 with little deterioration and high safety can be obtained.

This embodiment can be freely combined with any of the other embodiments.

### Embodiment 3

In this embodiment, a structure of a solid secondary battery will be described. In this specification, not only a secondary battery including only a solid electrolyte but also a secondary battery including a polymer gel electrolyte, a few amount of electrolyte, or a combination thereof is also referred to as a solid battery.

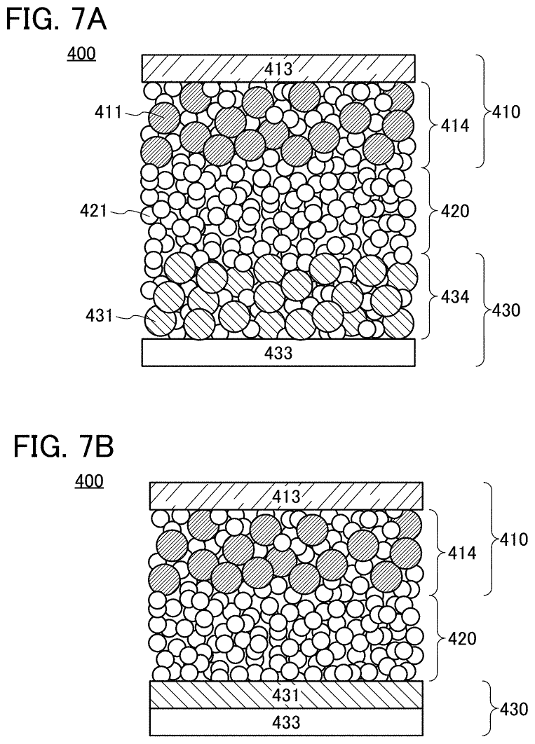

As illustrated in FIG. 7A, a secondary battery 400 that is the solid battery of one embodiment of the present invention includes a positive electrode 410, a solid electrolyte layer 420, and a negative electrode 430. FIG. 7A illustrates a case of using a solid electrolyte. When the solid electrolyte is used, a separator and a spacer are not necessary. Furthermore, the battery can be entirely solidified; therefore, there is no possibility of liquid leakage and thus the safety is dramatically increased.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material described in the above embodiment can be used. The positive electrode active material layer 414 may also include a conductive material and a binder. As the conductive material, a carbon material such as carbon black (e.g., acetylene black (AB)), graphite (black lead) particles, carbon nanotubes (CNT), or fullerene can be used. Alternatively, metal powder or metal fibers of copper, nickel, aluminum, silver, gold, or the like, a conductive ceramic material, or the like can be used. Alternatively, a graphene compound may be used as the conductive material. A graphene compound has excellent electrical characteristics of high conductivity and excellent physical properties of high flexibility and high mechanical strength in some cases. A graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. Hence, a graphene compound is preferably used as a conductive additive, in which case the area where the active material and the conductive additive are in contact with each other can be increased. In addition, a graphene compound is preferable because electrical resistance can be reduced in some cases. Here, examples of the graphene compound include graphene, multilayer graphene, multi graphene, graphene oxide, multilayer graphene oxide, multi graphene oxide, graphene oxide that is reduced, multilayer graphene oxide that is reduced, multi graphene oxide that is reduced, and graphene quantum dots. The graphene oxide that is reduced is also referred to as reduced graphene oxide (hereinafter RGO). Note that RGO refers to a compound obtained by reducing graphene oxide (GO), for example. In the case where an active material particle with a small particle diameter, e.g., 1 μm or less, is used, the specific surface area of the active material particle is large and thus more conductive paths for connecting the active material particles are needed. In such a case, a graphene compound that can efficiently form a conductive path even in a small amount is particularly preferably used. In this specification and the like, graphene oxide contains carbon and oxygen, has a sheet-like shape, and includes a functional group, specifically, an epoxy group, a carboxy group, or a hydroxy group. When a plurality of graphene compounds are bonded to each other, a net-like graphene compound sheet (hereinafter referred to as a graphene compound net or a graphene net) can be formed. The graphene net covering the active material can function as a binder for bonding active materials. The amount of binder can thus be reduced, or the binder does not have to be used. This can increase the proportion of the active material in the electrode volume or the electrode weight. That is, the capacity of the secondary battery can be increased.

The solid electrolyte layer 420 includes the solid electrolyte 421. The solid electrolyte layer 420 is positioned between the positive electrode 410 and the negative electrode 430, and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when metal lithium is used for the negative electrode 430, it is possible that the negative electrode 430 does not include the solid electrolyte 421 as illustrated in FIG. 7B. The use of metallic lithium for the negative electrode 430 is preferable because the energy density of the secondary battery 400 can be increased. Note that in FIG. 7A and FIG. 7B, the solid electrolyte 421, the positive electrode active material 411, and the negative electrode active material 431 have spherical shapes as ideal particle shapes; however, they actually have various shapes, and thus the shapes are schematically illustrated in the drawings for convenience.

As materials for the solid electrolyte 421 included in the solid electrolyte layer 420 and the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S.30P₂S₅, 30Li₂S.26B₂S₃.44LiI, 63Li₂S.38SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a conduction path after charge and discharge because of its relative softness.

Examples of the oxide-based solid electrolyte include a material with a perovskite crystal structure (e.g., La_{2/3-α}Li_{3α}TiO₃), a material with a NASICON crystal structure (e.g., Li_{1-A}Al_{A}Ti_{2-A}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Note that in this specification and the like, a material with a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

Examples of the halide-based solid electrolyte include LiAlCl₄, Li₃InBr₆, LiF, LiCl, LiBr, and LiI. Moreover, a composite material in which pores of porous alumina or porous silica are filled with such a halide-based solid electrolyte can be used as a solid electrolyte.

Alternatively, different kinds of solid electrolytes may be mixed and used.

Alternatively, an electrolyte solution may be mixed to a solid electrolyte.

As the electrolyte solution that is mixed with a solid electrolyte, an electrolyte solution that is highly purified and contains small amounts of dust particles and elements other than the constituent elements of the electrolyte solution (hereinafter also simply referred to as “impurities”) is preferably used. Specifically, the weight ratio of impurities to the electrolyte solution is preferably less than or equal to 1%, further preferably less than or equal to 0.1%, still further preferably less than or equal to 0.01%.

An additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution that is mixed with the solid electrolyte. The concentration of a material to be added in the whole solvent is, for example, higher than or equal to 0.1 wt % and lower than or equal to 5 wt %.

As the material mixed with the solid electrolyte, a polymer gel electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

This embodiment can be freely combined with any of the other embodiments.

### Embodiment 4

In this embodiment, examples of electronic devices or a vehicle each using the secondary battery of one embodiment of the present invention will be described.

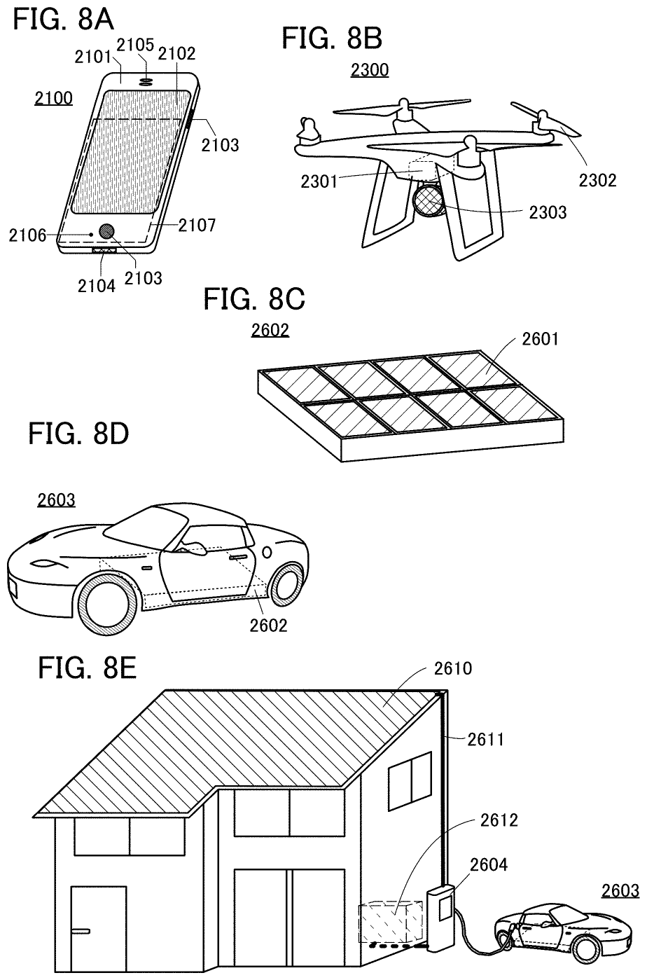

First, FIG. 8A to FIG. 8E illustrate examples of electronic devices each including the secondary battery using the positive electrode active material of one embodiment of the present invention. Examples of electronic devices each including the bendable battery include television devices (also referred to as televisions or television receivers), monitors for computers and the like, digital cameras, digital video cameras, digital photo frames, mobile phones (also referred to as cellular phones or mobile phone devices), portable game machines, portable information terminals, audio reproducing devices, and large game machines such as pachinko machines.

The secondary battery can also be used in moving vehicles, typically automobiles. Examples of the automobiles include next-generation clean energy vehicles such as hybrid vehicles (HVs), electric vehicles (EVs), and plug-in hybrid vehicles (PHVs or PHEVs), and the secondary battery can be used as one of the power sources provided for the automobiles. Furthermore, the moving object is not limited to an automobile. Examples of moving vehicles include a train, a monorail train, a ship, and a flying object (a helicopter, an unmanned aircraft (a drone), an airplane, and a rocket), electric vehicles, and electric motorcycles, and the secondary battery of one embodiment of the present invention can be used for the moving vehicles.

The secondary battery of this embodiment may be used in a ground-based charging apparatus provided for a house or a charging station provided in a commerce facility.

FIG. 8A illustrates an example of a mobile phone. A mobile phone 2100 includes a display portion 2102 installed in a housing 2101, an operation button 2103, an external connection port 2104, a speaker 2105, a microphone 2106, and the like. Note that the mobile phone 2100 includes a secondary battery 2107.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, by mutual communication between the mobile phone 2100 and a headset capable of wireless communication, hands-free calling can be performed.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a body-temperature sensor, a touch sensor, a pressure sensitive sensor, or an acceleration sensor is preferably mounted.

FIG. 8B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery of one embodiment of the present invention is preferable as a secondary battery mounted on the unmanned aircraft 2300 because it has a high level of safety and thus can be used safely for a long time over a long period.

Furthermore, as illustrated in FIG. 8C, a secondary battery 2602 including a plurality of secondary batteries 2601 of one embodiment of the present invention may be mounted on a hybrid electric vehicle (HV), an electric vehicle (EV), a plug-in hybrid electric vehicle (PHV or PHEV), or another electronic device.

FIG. 8D illustrates an example of a vehicle including the secondary battery 2602. A vehicle 2603 is an electric vehicle that runs using an electric motor as a power source. Alternatively, the vehicle 2603 is a hybrid electric vehicle that can appropriately select an electric motor or an engine as a driving power source.

The environment temperature of a lithium ion battery mounted on a vehicle sometimes becomes high due to heat generation while running, blazing heat in a hot summer day, or the like. Accordingly, the use of the secondary battery of one embodiment of the present invention, which has high cycle performance even in a high-temperature environment, can provide a highly reliable vehicle.

The vehicle 2603 using an electric motor includes a plurality of ECUs (Electronic Control Units) and performs engine control by the ECUs. The ECU includes a microcomputer. The ECU is connected to a CAN (Controller Area Network) provided in the electric vehicle. The CAN is a type of a serial communication standard used as an in-vehicle LAN. The secondary battery of one embodiment of the present invention can be used to function as a power source of ECU and a vehicle with a high level of safety and a long cruising range can be achieved.

The secondary battery not only drives the electric motor (not illustrated) but also can supply electric power to a light-emitting device such as a headlight or a room light. Furthermore, the secondary battery can supply electric power to a display device and a semiconductor device included in the vehicle 2603, such as a speedometer, a tachometer, and a navigation system.

In the vehicle 2603, the secondary batteries included in the secondary battery 2602 can be charged by being supplied with electric power from external charging equipment by a plug-in system, a contactless power feeding system, or the like.

FIG. 8E illustrates a state in which the vehicle 2603 is supplied with electric power from ground-based charging equipment 2604 through a cable. In charging, a given method such as CHAdeMO (registered trademark) or Combined Charging System may be employed as a charging method, the standard of a connector, or the like as appropriate. For example, with a plug-in technique, the secondary battery 2602 incorporated in the vehicle 2603 can be charged by being supplied with electric power from the outside. Charging can be performed by converting AC power into DC power through a converter such as an ACDC converter. The charging equipment 2604 may be provided for a house as illustrated in FIG. 8E, or may be a charging station provided in a commercial facility.

Although not illustrated, the vehicle can include a power receiving device so as to be charged by being supplied with power from an above-ground power transmitting device in a contactless manner. In the case of the contactless power feeding system, by fitting a power transmitting device in a road or an exterior wall, charging can be performed not only when the vehicle is stopped but also when is running. In addition, this contactless power feeding system may be utilized to transmit and receive power between vehicles. Furthermore, a solar cell may be provided in the exterior of the vehicle to charge the secondary battery when the vehicle stops or moves. To supply power in such a contactless manner, an electromagnetic induction method or a magnetic resonance method can be used.

The house illustrated in FIG. 8E includes a power storage system 2612 including the secondary battery of one embodiment of the present invention and a solar panel 2610. The power storage system 2612 is electrically connected to the solar panel 2610 through a wiring 2611 or the like. The power storage system 2612 may be electrically connected to the ground-based charging equipment 2604. The power storage system 2612 can be charged with electric power generated by the solar panel 2610. The secondary battery 2602 included in the vehicle 2603 can be charged with the electric power stored in the power storage system 2612 through the charging equipment 2604.

The electric power stored in the power storage system 2612 can also be supplied to other electronic devices in the house. Thus, with the use of the power storage system 2612 of one embodiment of the present invention as an uninterruptible power source, electronic devices can be used even when electric power cannot be supplied from a commercial power source due to power failure or the like.

This embodiment can be implemented in appropriate combination with any of the other embodiments.

### EXAMPLE 1

In this example, as a positive electrode active material containing the transition metal M, a Li—Co—Ni oxide (0≤x<1) was fabricated in which the molar ratio of the metal elements is Li: Co:Ni=1.03:1−x: x, and the characteristics were evaluated. In addition, cycle performance in high-voltage charging was evaluated. Furthermore, nine samples (Sample 1A, Sample 1B, Sample 1C, Sample 1D, Sample 1E, Sample 1F, Sample 1G, Sample 1H, and Sample 1J) were formed.

### <Fabrication of Positive Electrode Active Material>

As Sample 1A, a positive electrode active material containing cobalt as the transition metal M was fabricated. As Sample 1B, Sample 1C, Sample 1D, Sample 1E, Sample 1F, Sample 1G, Sample 1H, and Sample 1J, positive electrode active materials containing cobalt and nickel as the transition metal M were fabricated. Note that each sample has a different molar ratio of nickel and cobalt.

First, a composite oxide containing cobalt was formed. Li₂CO₃, Co₃O₄, and Ni(OH)₂ were measured according to the molar ratios in the following table as design values, and then mixed and ground. Note that the mixing and the grinding were performed by a wet process using acetone in a ball mill using a zirconia ball at 200 rpm for 12 hours. Subsequently, heat treatment was performed at 950° C. in an air atmosphere for 10 hours. The material that has been subjected to the treatment was collected to obtain each sample as a positive electrode active material.

In the nine samples (Sample 1A, Sample 1B, Sample 1C, Sample 1D, Sample 1E, Sample 1F, Sample 1G, Sample 1H, and Sample 1J) fabricated in the above manner, the design values of the molar ratio x of nickel in the Li—Co—Ni oxide are listed in the following table.

TABLE 1

| | Molar ratio of | |
|---|---|---|
| | Li₂CO₃:Co₃O₄:Ni(OH)₂ | Molar ratio x of Ni |
| Sample 1A | 0.51500:0.33333:0.00000 | 0 |
| Sample 1B | 0.51500:0.31667:0.05000 | 0.05 |
| Sample 1C | 0.51500:0.30000:0.10000 | 0.1 |
| Sample 1D | 0.51500:0.26667:0.20000 | 0.2 |
| Sample 1E | 0.51500:0.20000:0.40000 | 0.4 |
| Sample 1F | 0.51500:0.16667:0.50000 | 0.5 |
| Sample 1G | 0.51500:0.13333:0.60000 | 0.6 |
| Sample 1H | 0.51500:0.10000:0.70000 | 0.7 |
| Sample 1J | 0.51500:0.06667:0.80000 | 0.8 |

### <Fabrication of Secondary Battery>

For evaluation, CR2032 type coin-type secondary batteries (a diameter of 20 mm, a height of 3.2 mm) were fabricated.

As positive electrode active materials of the secondary batteries, Sample 1A, Sample 1B, Sample 1C, Sample 1D, Sample 1E, Sample 1F, Sample 1G, Sample 1H, and Sample 1J fabricated above were used.

Acetylene black was used as a conductive material in each positive electrode active material. This is reduced in a later step. As a binder, PVDF (TA5130 produced by Solvay) was used. The positive electrode active material, the conductive material, and the binder were mixed at a ratio of 95:3:2 (wt %) to form slurry. NMP was used as a solvent. The slurry was applied on a current collector and dried. Aluminum foil was used for the current collector.

Next, a drying treatment was performed. The drying treatment was performed in such a manner that heat treatment was performed in a ventilation drying furnace at a set temperature of 50° C. for one hour, and then, the set temperature was increased to 80° C. and a heat treatment is performed at 80° C. for 30 minutes.

Next, application of linear pressure at 210 kN/m was performed and then application of linear pressure at 1467 kN/m was further performed to form the positive electrode.

A lithium metal was used for a counter electrode.

As an electrolyte included in an electrolytic solution, 1 mol/L lithium hexafluorophosphate (LiPF₆) was used. As the electrolytic solution, a solution in which ethylene carbonate (EC) and diethyl carbonate (DEC) were mixed at a volume ratio of EC:DEC=3:7 and vinylene carbonate (VC) was added as an additive agent at 2 wt % was used.

As a separator, 25-μm-thick polypropylene was used.

A positive electrode can and a negative electrode can that were formed using stainless steel (SUS) were used.

<Bond Distance dₐᵥₑ and Bond Angle θₐᵥₑ Obtained from XRD Result>

Sample 1A to Sample 1J obtained in the above-described manner were evaluated with X-ray diffraction (XRD). The results obtained from the X-ray diffraction were analyzed, and the lattice constant and the atomic position of each sample were calculated. Note that the powder of each sample was fixed to a reflection-free Si plate thinly applied with Apiezon grease and measured by an out-of-plane method.

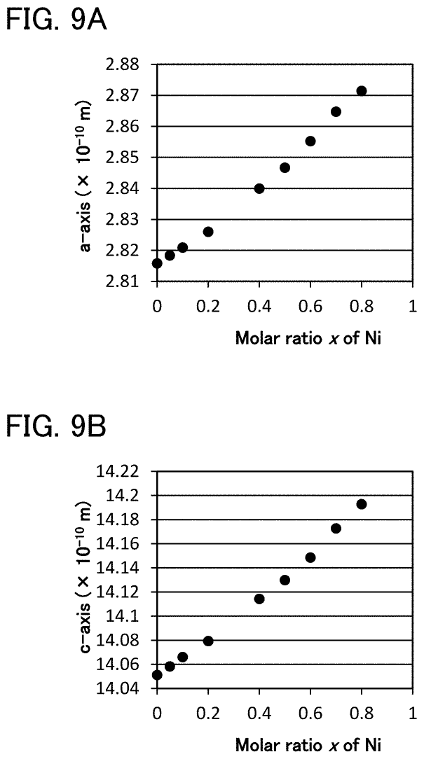

Here, the lattice constant and the atomic position were calculated by Rietveld analysis. As analysis software, TOPAS (DIFFRAC PLUS TOPAS Version 3) of Bruker AXS was used. The structure of the space group R-3m was used for Rietveld analysis, and fitting was performed, so that the lattice constant and the atomic position were calculated. FIG. 9A shows the calculation results of the lattice constants of the a-axis, and FIG. 9B shows the calculation results of the lattice constants of the c-axis. The lattice constants (a-axis, c-axis) and the z coordinate of oxygen are listed in the following table.

TABLE 2

| Lattice constant of | Lattice constant of | |
|---|---|---|
| a-axis | c-axis | z coordinate |
| (×10⁻¹⁰ m) | (×10⁻¹⁰ m) | of oxygen |
| 2.816 | 14.05 | 0.2380 |
| 2.818 | 14.06 | 0.2386 |
| 2.821 | 14.07 | 0.2402 |
| 2.826 | 14.08 | 0.2404 |
| 2.840 | 14.11 | 0.2431 |
| 2.847 | 14.13 | 0.2433 |
| 2.855 | 14.15 | 0.2424 |
| 2.865 | 14.17 | 0.2378 |
| 2.871 | 14.19 | 0.2337 |

Next, the bond distance d and the bond angle θ of each sample were calculated with the lattice constants (a-axis, c-axis) calculated from XRD, the coordinate of each element, the coordinate of the space group R-3m and Li (0, 0, 0), the coordinate of the transition metal M (0, 0, 0.5), and the coordinate of oxygen (0, 0, z).

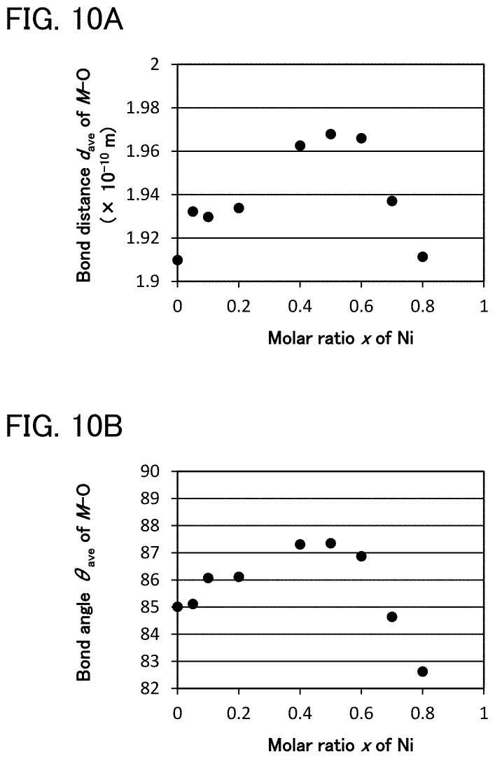

FIG. 10A shows the calculation results of the bond distances dₐᵥₑ between the transition metal M and oxygen in the samples, and FIG. 10B shows the calculation results of the bond angle θₐᵥₑ.

As shown in FIG. 10A, it was found that when the molar ratio x of nickel is 0.2<x<0.7 in the Li—Co—Ni oxide in which the molar ratio of the metal elements is Li:Co:Ni=1.03:1−x: x, the bond distance dₐᵥₑ is longer than or equal to 1.94×10⁻¹⁰ m. In particular, when x is 0.4≤x≤0.6, the bond distance dₐᵥₑ is longer than or equal to 1.96×10⁻¹⁰ m.

As shown in FIG. 10B, it was found that when x is 0.2<x<0.7, the bond angle θₐᵥₑ is greater than or equal to 86.5°. In particular, when xis 0.4<x≤0.5, the bond angle θₐᵥₑ is greater than or equal to 87°.

### <Battery Characteristics and Cycle Performance>

Next, charge and discharge tests were performed on the coin-type secondary batteries using the samples. In the measurement, the CCCV charge (0.5 C, 4.6 V, a termination current of 0.05 C) and the CC discharge (0.5 C, a termination voltage of 2.5 V) were performed at 65° C. Note that 1 C was set to 200 mAh/g in this example and the like.

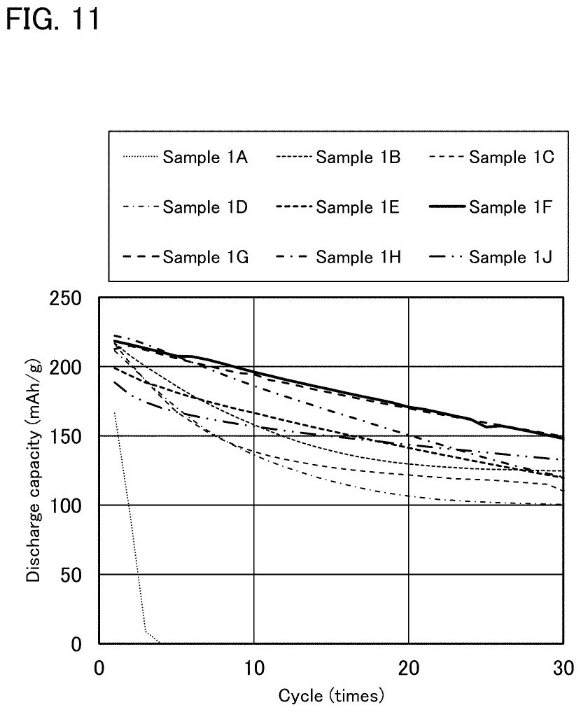

FIG. 11 shows charge and discharge curves of the samples. With Sample 1A (a Li—Co oxide), cycle performance was not obtained when the environment temperature was 65° C., which is high. On the other hand, with Sample 1B to Sample 1J (Li—Co—Ni oxides), favorable cycle performance was obtained when the environment temperature was 65° C.

It was found that when the molar ratio x of nickel is 0.4<x<0.7 in the Li—Co—Ni oxide in which the molar ratio of the metal elements is Li:Co:Ni=1.03:1−x: x, favorable cycle performance is obtained. It was also found that when x is 0.5≤x≤0.6, particularly favorable cycle performance is obtained.

As described above, the secondary batteries using Li—Co—Ni oxides as the positive electrode active materials were favorable in discharge characteristics and the like.

According to the above, it is clear from FIG. 10A and FIG. 11 that the cycle performance in a high-temperature environment has a correlation with the bond distance dₐᵥₑ between the transition metal M and oxygen in the positive electrode active material. In particular, it can be presumed that when the bond distance dₐᵥₑ is longer than or equal to 1.96×10⁻¹⁰ m, favorable cycle performance can be obtained even in a high-temperature environment.

In addition, according to the above, it is clear from FIG. 10B and FIG. 11 that the cycle performance in a high-temperature environment has a correlation with the bond angle θₐᵥₑ. Therefore, it can be presumed that when the bond angle θₐᵥₑ between the transition metal M and oxygen in the positive electrode active material is greater than or equal to 86.5°, favorable cycle performance can be obtained even in a high-temperature environment.

This embodiment can be implemented in combination with the other embodiments or the other example.

### EXAMPLE 2

In this example, as a positive electrode active material containing the transition metal M, a Li—Co—Ni oxide was fabricated in which the molar ratio of lithium to the transition metal is Li: Co:Ni=1.03:0.5:0.5 and magnesium (Mg) that is a contained element is contained, and cycle performance in high-voltage charging was evaluated. Note that the magnesium that is a contained element has 1.0 atomic% to the Li—Co—Ni oxide.

### <Fabrication of Positive Electrode Active Material>

Sample 2F was formed as a positive electrode material measured in this example. First, LiF and MgF₂ were measured so that the molar ratio of LiF to MgF₂ was LiF:MgF₂=1:3, acetone was added as a solvent, and the materials were mixed and ground by a wet process. The mixing and the grinding were performed by a wet process using acetone in a ball mill using a zirconia ball at 150 rpm for 1 hour. The material that has been subjected to the treatment was collected to be a first mixture.

Next, a composite oxide containing cobalt was formed. Li₂CO₃, Co₃O₄, and Ni(OH)₂ were measured to have the molar ratios in the following table, and then mixed and ground. The mixing and the grinding were performed in a ball mill using a zirconia ball at 200 rpm for 12 hours. Subsequently, heat treatment was performed at 950° C. in a nitrogen atmosphere for 10 hours. The material that has been subjected to the treatment was collected to be a second mixture.

The first mixture and the second mixture were mixed. The mixing was performed in a ball mill using a zirconia ball at 150 rpm for 1 hour. The material that has been subjected to the treatment was collected to obtain Sample 2F as a positive electrode active material.

### <Fabrication of Secondary Battery>

For evaluation, a CR2032 type coin-type secondary battery (a diameter of 20 mm, a height of 3.2 mm) was fabricated.

As a positive electrode active material of the secondary battery, Sample 2F fabricated above was used.

Acetylene black was used as a conductive material in each positive electrode active material. This is reduced in a later step. As a binder, PVDF (TA5130 produced by Solvay) was used. The positive electrode active material, the conductive material, and the binder were mixed at a ratio of 95:3:2 (wt %) to form slurry. NMP was used as a solvent. The slurry was applied on a current collector and dried. Aluminum foil was used for the current collector.

Next, a drying treatment was performed. The drying treatment was performed in such a manner that heat treatment was performed in a ventilation drying furnace at a set temperature of 50° C. for one hour, and then, the set temperature was increased to 80° C. and a heat treatment is performed at 80° C. for 30 minutes.

Next, application of linear pressure at 210 kN/m was performed and then application of linear pressure at 1467 kN/m was further performed to form the positive electrode.

A lithium metal was used for a counter electrode.

As an electrolyte included in an electrolytic solution, 1 mol/L lithium hexafluorophosphate (LiPF₆) was used. As the electrolytic solution, a solution in which ethylene carbonate (EC) and diethyl carbonate (DEC) were mixed at a volume ratio of EC: DEC=3:7 and vinylene carbonate (VC) was added as an additive agent at 2 wt % was used.

As a separator, 25-μm-thick polypropylene was used.

A positive electrode can and a negative electrode can that were formed using stainless steel (SUS) were used.

### <Battery Characteristics and Cycle Performance>

Next, a charge and discharge test was performed on the coin-type secondary battery using Sample 2F. In the measurement, the CCCV charge (0.5 C, 4.6 V, a termination current of 0.05 C) and the CC discharge (0.5 C, a termination voltage of 2.5 V) were performed. The measurement temperatures were 25° C., 65° C., and 85° C. Note that 1 C was set to 200 mAh/g in this example and the like.

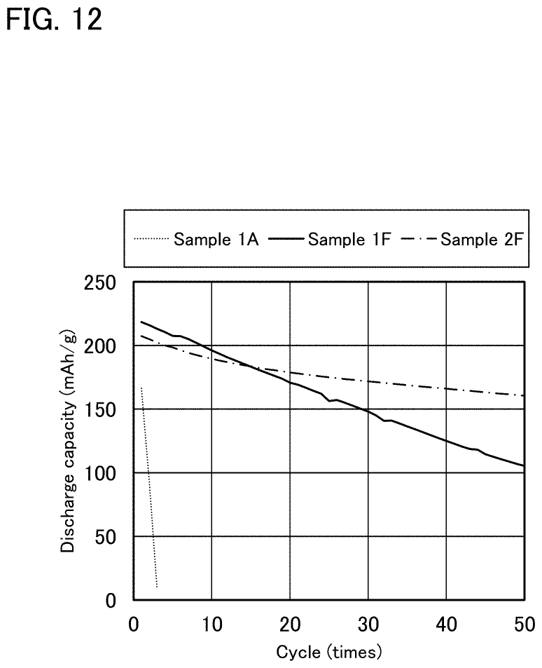

FIG. 12 shows a charge and discharge curve of Sample 2F at a measurement temperature of 65° C. Note that in FIG. 12, Sample 1A and Sample 1F fabricated in the above example are shown as comparative examples.

With Sample 1A (a Li—Co oxide), cycle performance was not obtained when the environment temperature was high. On the other hand, with Sample 1F (a Li—Co—Ni oxide) and Sample 2F (a Li—Co—Ni oxide containing Mg as a contained element), favorable cycle performance was obtained when the environment temperature was 65° C.

In particular, favorable cycle performance was obtained with Sample 2F when the environment temperature was 65° C.

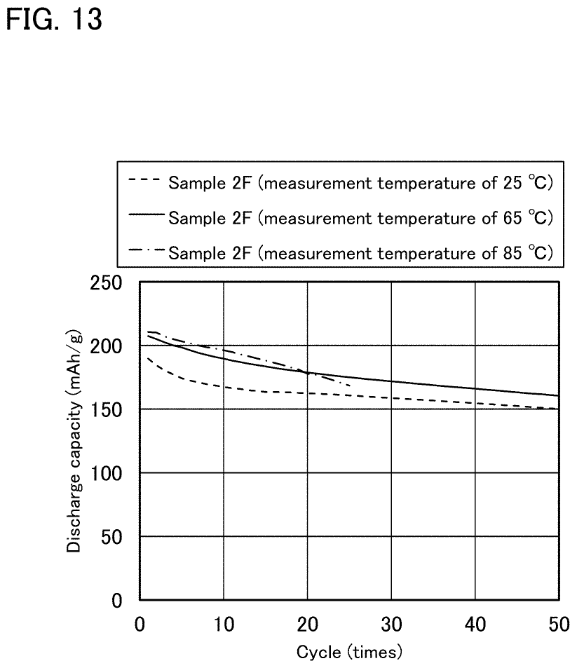

FIG. 13 shows the measurement results of charge and discharge curves of Sample 2F at 25° C., 65° C., and 85° C. It was found from FIG. 13 that favorable cycle performance is obtained with Sample 2F regardless of an environment temperature.

From the above, when a Li—Co—Ni oxide contains Mg at 1 wt % as a contained element, cycle performance in a high-temperature environment is improved.

This embodiment can be implemented in combination with the other embodiments or the other example.

### REFERENCE NUMERALS

100: positive electrode active material, 102: layer, 104: layer, 106: line, 108: region

1. A positive electrode active material comprising lithium, cobalt, a transition metal M, and oxygen,
wherein a molar ratio of the lithium, the cobalt, and the transition metal M is the lithium: the cobalt: the transition metal M=1.03: 1−x: x (0.3<x<0.75).

2. A positive electrode active material comprising lithium, cobalt, a transition metal M, and oxygen,
wherein a molar ratio of the lithium, the cobalt, and the transition metal M is the lithium: the cobalt: the transition metal M=1.03:1−x: x (0.4≤x≤0.6).

3. The positive electrode active material according to claim 1,
wherein the transition metal M is nickel.

4. A positive electrode active material comprising lithium, a transition metal M, and oxygen,
wherein an average of a bond distance d between the transition metal M and the oxygen is longer than or equal to 1.94×10⁻¹⁰ m and shorter than or equal to 2.1×10⁻¹⁰ m in a crystal structure of the positive electrode active material.

5. A positive electrode active material comprising lithium, a transition metal M, and oxygen,
wherein an average of an angle θ formed between a line connecting the transition metal M to an adjacent oxygen and a line connecting the transition metal M to another adjacent oxygen is greater than or equal to 86.5° and less than 90° in a crystal structure of the positive electrode active material.

6. The positive electrode active material according to claim 4,
wherein the transition metal M is cobalt and nickel.

7. A positive electrode active material comprising lithium, cobalt, nickel, and oxygen,
wherein a molar ratio of the lithium, the cobalt, and the nickel is the lithium: the cobalt: the nickel=1:1−x: x (0.3<x<0.75),
wherein a bond distance d that is an average of a bond distance d_{Co} between the cobalt and the oxygen and a bond distance d_{Ni} between the nickel and the oxygen is longer than or equal to 1.94×10⁻¹⁰ m and shorter than or equal to 2.1×10⁻¹⁰ m in a crystal structure of the positive electrode active material,
wherein an angle θ that is an average of an angle θ_{Co} formed between a line connecting the cobalt to an adjacent oxygen and a line connecting the cobalt to another adjacent oxygen and an angle θ_{Ni} formed between a line connecting the nickel to an adjacent oxygen and a line connecting the nickel to another adjacent oxygen is greater than or equal to 86.5° and less than 90° in a crystal structure of the positive electrode active material.

8. A secondary battery comprising the positive electrode active material according to claim 1.

9. An electronic device comprising the secondary battery according to claim 8.

10. A vehicle comprising the secondary battery according to claim 8.

11. The positive electrode active material according to claim 2,
wherein the transition metal M is nickel.

12. The positive electrode active material according to claim 5,
wherein the transition metal M is cobalt and nickel.
